(19) United States
(12) Patent Application Publication
(10) Pub. No.: US 2026/0277662 A1
(43) Pub. Date: Sep. 17, 2026

(54) INTERRUPT RATE CONTROL IN A DATA TRANSFORM ACCELERATOR

(71) Applicant: MaxLinear, Inc., Carlsbad, CA (US)

(72) Inventors: Jack Ping Chng, Singapore (SG); Cheol Yong Kim, Singapore (SG); Pinaki Shankar Chanda, San Diego, CA (US)

(73) Assignee: MaxLinear, Inc., Carlsbad, CA (US)

(21) Appl. No.: 19/564,132

(22) Filed: Mar. 11, 2026

Related U.S. Application Data
(60) Provisional application No. 63/770,331, filed on Mar. 11, 2025.

(51) Int. Cl. G06F 9/48; G06F 9/50

(52) U.S. Cl. CPC G06F 9/4812; G06F 9/5027; G06F 2209/508

(57) ABSTRACT

A method may include obtaining, by a host device, multiple interrupts from a data transform accelerator. The method may also include determining, by the host device, a first interrupt rate and a second interrupt rate. The method may further include determining, by the host device, an interrupt ratio based on the first interrupt rate relative to the second interrupt rate. The method may also include comparing the interrupt ratio to an interrupt threshold. The method may further include directing, by the host device, the data transform accelerator to adjust an interrupt throttle value associated with the multiple interrupts. The adjusting of the interrupt throttle value may be in response to the interrupt ratio satisfying the interrupt threshold.

### CROSS REFERENCE TO RELATED APPLICATIONS

This U.S. Patent Application claims priority to U.S. Provisional Patent Application No. 63/770,331, titled “INTERRUPT RATE CONTROL IN A DATA TRANSFORM ACCELERATOR,” and filed on Mar. 11, 2025, the disclosure of which is hereby incorporated by reference in its entirety.

### TECHNICAL FIELD

This disclosure relates to data transform acceleration, and more specifically, to interrupt rate control in a data transform accelerator.

### BACKGROUND

Unless otherwise indicated herein, the materials described herein are not prior art to the claims in the present application and are not admitted to be prior art by inclusion in this section.

Data transform accelerators are co-processor devices that are used to accelerate data transform operations for various applications such as data analytics applications, big data applications, storage applications, cryptographic applications, and networking applications. For example, a data transform accelerator can be configured as a storage accelerator and/or a cryptographic accelerator.

The subject matter claimed in the present disclosure is not limited to implementations that solve any disadvantages or that operate only in environments such as those described above. Rather, this background is only provided to illustrate one example technology area where some embodiments described in the present disclosure may be practiced.

### SUMMARY

In an example embodiment, a method may include obtaining, by a host device, multiple interrupts from a data transform accelerator. The method may also include determining, by the host device, a first interrupt rate and a second interrupt rate. The method may further include determining, by the host device, an interrupt ratio based on the first interrupt rate relative to the second interrupt rate. The method may also include comparing the interrupt ratio to an interrupt threshold. The method may further include directing, by the host device, the data transform accelerator to adjust an interrupt throttle value associated with the multiple interrupts. The adjusting of the interrupt throttle value may be in response to the interrupt ratio satisfying the interrupt threshold.

In another embodiment, a system may include a processor and a memory. The memory may be operable to store instructions that, when executed by the processor, may cause the computing system to obtain, by a host device, multiple interrupts from a data transform accelerator. The computing system may also be operable to determine, by the host device, a first interrupt rate and a second interrupt rate. The computing system may further be operable to determine, by the host device, an interrupt ratio based on the first interrupt rate relative to the second interrupt rate. The computing system may also be operable to compare the interrupt ratio to an interrupt threshold. The computing system may further be operable to direct, by the host device, the data transform accelerator to adjust an interrupt throttle value associated with the multiple interrupts. The adjusting of the interrupt throttle value may be in response to the interrupt ratio satisfying the interrupt threshold.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for interrupt rate control in a data transform accelerator;

FIG. 2 illustrates an example flowchart for interrupt rate control in a data transform accelerator;

FIG. 3 illustrates another example flowchart for interrupt rate control in a data transform accelerator;

FIG. 4 illustrates a flowchart of an example method for interrupt rate control in a data transform accelerator; and

FIG. 5 illustrates an example computing device.

### DETAILED DESCRIPTION

A data transform accelerator may be used as a coprocessor device in conjunction with a host device or server (referred to as host device unless otherwise explicitly stated) to accelerate data transform operations for various applications, such as data analytics, big data, storage, and/or networking applications. The data transform operations may include, but not be limited to, compression, decompression, encryption, decryption, authentication tag generation, authentication, data deduplication, non-volatile memory express (NVMe) protection information (PI) generation, NVMe PI verification, and/or real-time verification. Such data transform accelerators may be connected to the host device using one or more various interface technologies, such as Peripheral Component Interconnect Express (PCIe), Universal Serial Bus (USB), Unified Configuration Interface (UCI), etc.

The data transform accelerator may be operable to perform compression and/or security acceleration with low latency and/or high throughput. Packets and/or data transmitted to the data transform accelerator (such as from the host device) for transformation may be initially stored in a ring or container associated with the data transform accelerator. Once transform operations may be completed, the data transform accelerator may generate an interrupt (e.g., a “command done” interrupt) that may be used to notify the host device that the transformation is complete. In some instances, the interrupt may be transmitted from the data transform accelerator to the host device using an interface (e.g., PCIe) between the data transform accelerator and the host device as a message signaled interrupt (MSI)-X interrupt.

In response to receiving the command done interrupt, the host device may begin an interrupt service routine, where a tasklet/thread may be scheduled to process the packet in the container. In instances in which a host processor of the host device is under a heavy load associated with processing the command done interrupts and/or when resources associated with the host device (e.g., number of CPU cores, clock frequency of the CPU cores, etc.) are inadequate, the interrupt handling and/or result processing time associated with the interrupt handling may be exceed a threshold amount of time – where before a first interrupt completes, a second interrupt may be obtained from the data transform accelerator. In such instances, the tasklet/thread that may be processing the first result associated with the first interrupt may find a second result for another command in the container of the data transform accelerator and process the second result. In such instances, at a subsequent time in which the host processor processes the second interrupt, the second interrupt may not be associated with the second result. In some instances, a no packet interrupt may be referred to as a stale interrupt (e.g., an interrupt with no pending work/processing to be performed), where a particular packet associated with the most recent command done interrupt may have been handled by processing associated with a previous interrupt. Under such circumstances, it may be detrimental to process interrupts that may not have any results associated with them. Alternatively, or additionally, the presence of interrupts that may not have associated results may be an indication of a high load in the host device and/or a drop in data processing throughput may be present. As described herein, the presence of a stale interrupt may be used as a feedback mechanism to at least control the load of the interrupt processing and/or freeing up potential bottleneck of the host device. Alternatively, or additionally, processing interrupts that may not have a result associated with them may be removed.

In at least some aspects of the present disclosure, control of interrupts and/or a rate at which interrupts may be transmitted from the data transform accelerator to the host device may reduce or eliminate stale interrupts. As the stale interrupt (e.g., the command done interrupt with no pending work) appears to be correlated with the load on the host device, moderating the interrupts from the data transform accelerator may reduce the rate of the command done interrupt. In some instances, controlling interrupts based on the stale interrupt rate may help moderate an interrupt throttle value corresponding to the additional load in the host software which the host device may not be able to handle and/or which may cause a degradation in throughput. This may help in reducing the load from interrupt processing in the host processor. In some instances, moderating the interrupts may include adjusting the interrupt throttle value associated with an interrupt throttle register in the data transform accelerator.

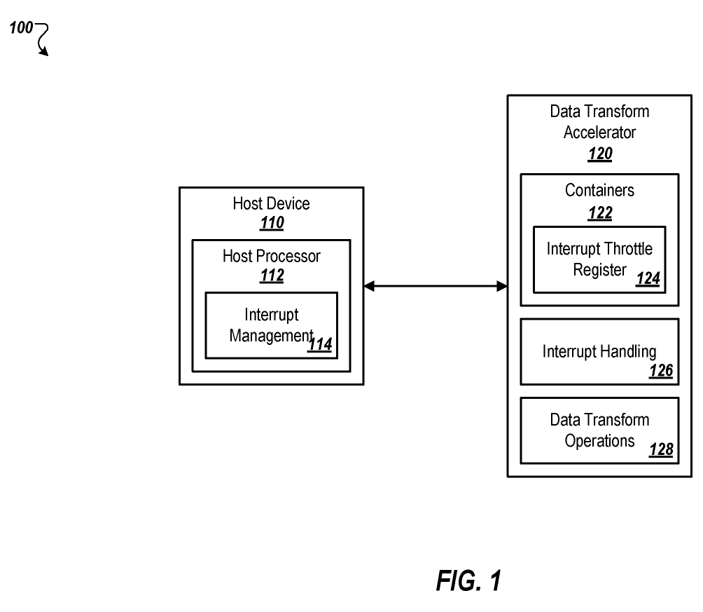

FIG. 1 illustrates a block diagram of an example system 100 for interrupt rate control in a data transform accelerator. The system 100 may include a host device 110 and a data transform accelerator 120. The host device 110 may include a host processor 112, which may be operable to perform interrupt management 114. The data transform accelerator 120 may include containers 122, interrupt handling 126, and may be operable to perform data transform operations 128. The containers 122 may include an interrupt throttle register 124.

In some instances, the host device 110 may be operable to communicate with the data transform accelerator 120. For example, the host device 110 may communicate with the data transform accelerator 120 using one or more various interface technologies, such as Peripheral Component Interconnect Express (PCIe), Universal Serial Bus (USB), Unified Configuration Interface (UCI), and so forth. In some instances, the host processor 112 may provide data and/or instructions to the data transform accelerator 120 to perform the data transform operations 128. The host processor 112 may provide the data to the data transform accelerator 120 in the containers 122, and/or the containers 122 may be used in various stages of performance of the data transform operations 128.

In instances in which the data transform accelerator 120 completes the data transform operations 128, the completed packet may be stored in the containers 122 to be retrieved by the host device 110 at a later time. Alternatively, or additionally, the data transform accelerator 120 may generate an interrupt (e.g., a command done interrupt) associated with the completed packet. The command done interrupt may be transmitted to the host device 110, such as via an MSI-X interrupt over PCIe. Alternatively, or additionally, an interrupt mask may be automatically applied such that no additional interrupts from the containers 122 may be transmitted to the host device 110 while a particular interrupt is masked, and the additional interrupts may be transmitted to the host device 110 after the particular interrupt is unmasked.

In some instances, the interrupt management 114 may obtain the interrupt and may begin performing an interrupt service routine, which may include scheduling a tasklet/thread to process the packet obtained from the data transform accelerator 120 (e.g., from the containers 122. The host device 110 may process the packet obtained from the containers 122, and after the packets have been processed, the host device 110 and/or the interrupt management 114 may determine to mask the interrupt to the data transform accelerator 120. The unmask interrupt may be transmitted from the data transform accelerator 120, such that a subsequent interrupt associated with packet processing may be transmitted to and/or received by the host device 110, from the data transform accelerator 120.

The interrupt handling 126 may include an interrupt throttle that may be a mechanism in the data transform accelerator 120 operable to generate an interrupt throttle value associated with interrupts, where the interrupt throttle value may be associated with a minimum duration between the interrupts such that the interrupts may be less than a threshold number of interrupts. By having the interrupt throttle value below the threshold number of interrupts, the data transform accelerator 120, the host device 110, and/or the interface between the two may not become overwhelmed as one or more packets may be processed for each interrupt and/or interrupt context switching may be occurring at a reduced rate. The processing of additional packets per interrupt and/or the reduced interrupt context switching may help reduce the load on the host processor 112 and/or may contribute to an improvement in the throughput of processing the data.

The interrupt handling 126 may include interrupt rate control, which may refer to adjustments to the interrupt throttle value that may contribute to reducing or eliminating a number of the stale interrupts per container. In some instances, the interrupt rate control may analyze sampled data (e.g., during runtime of the data transform accelerator 120) over a particular time interval. In some instances, the sampled data may include a number of stale interrupts and/or a total number of interrupts. In instances in which a stale interrupt ratio (e.g., a ratio of the number of stale interrupts to the total number of interrupts) exceeds an upper stale interrupt threshold, the interrupt throttle value may be set/adjusted within the interrupt throttle register 124 in the containers 122 (e.g., the interrupt throttle value may be adjusted higher which may cause the number of interrupts from the data transform accelerator 120 to be reduced). Alternatively, or additionally, in instances in which the stale interrupt ratio is below a lower stale interrupt threshold, the interrupt throttle value may be adjusted lower and/or the interrupt throttle may be disabled. In such instances, the number of interrupts from the data transform accelerator 120 to the host device 110 may be increased. Such an adjustment may be performed in view of the host processor 112 and/or the interrupt management 114 having ample resources to sustain the interrupt processing load.

In some instances, the thresholds (e.g., the upper stale interrupt threshold and/or the lower stale interrupt threshold) may be determined empirically, may be derived from synthetic workload testing, and/or obtained by monitoring a workload on the system 100 (e.g., a mission workload on the system 100). Alternatively, or additionally, the thresholds may be established by analyzing characteristics associated with the system 100. For example, the characteristics may include compute capability associated with the host device 110 and/or the data transform accelerator 120, memory bandwidth associated with the host device 110 and/or the data transform accelerator 120, and/or other hardware parameters that may influence throughput and/or latency.

In some instances, the stale interrupt rate may be determined as a current number of stale interrupts less a previous number of stale interrupts. Similarly, a total interrupt rate may be determined as a current number of total interrupts less a previous number of total interrupts. Both the stale interrupts and the total interrupts may be sampled over a time interval. Based on the stale interrupt rate and the total interrupt rate, a stale interrupt ratio may be determined as a ratio of the stale interrupt rate divided by the total interrupt rate.

In some instances, a metric of stale interrupts may vary based on an implementation where the stale interrupt metric may be defined as a total number of additional pending results each interrupt picks up. Without a stale interrupt, the total number of pending results may be equal to one. With a stale interrupt, the total number of pending results may be more than one.

In some instances, the interrupt rate control described herein may be utilized based on a class of service associated with the data transform accelerator 120, data transform engines within the data transform accelerator 120, and/or the containers 122. In some instances, each of the containers 122 may have interrupt rate control individually enabled and/or disabled. In some instances, the class of service may be used to group commands, such that each class of service may receive differential treatment based on the class of service (e.g., differences in latency and/or differences in throughput based on class of service). In some instances, the containers 122 may be individually associated with a class of service and the interrupt rate control corresponding to the containers 122 may be enabled or disabled for the class of service. For example, in instances in which a particular class of service is configured for low latency, the interrupt rate control may be disabled for the first class of service. In such instances, the disabling of the interrupt rate control for the particular class of service may be at a cost of a higher CPU utilization and/or higher throughput for the data transform operations 128 associated with the particular class of service.

In some embodiments, the host device 110 may implement software controls that may be utilized to perform an interrupt rate control. As part of an initialization, a global configuration for the containers 122 may be performed, including a determination of when interrupt values may be made. In some instances, interrupt rate control may be enabled and/or disabled based on a particular class of service. For example, a first class of service may have interrupt rate control enabled and a second class of service may have interrupt rate control disabled. In some instances, when interrupt rate control is enabled for a particular class of service, all of the containers 122 associated with the particular class of service may have interrupt rate control enabled. Alternatively, or additionally, interrupt rate control may be enabled/disabled on a container by container basis.

In some instances, the software controls may vary the interrupt throttle value (e.g., reduction or increment) iteratively, and/or the software controls may apply the iterative interrupt throttle value to the containers (e.g., all the containers associated with the data transform accelerator 120, or all the containers 122 associated with a class of service). In instances in which an amount of time between interrupts satisfies a threshold time, the interrupt throttle values may be reset.

In some instances, a number of interrupt values may be initialized for each container, including an interrupt accumulation, a stale interrupt accumulation, a current interrupt throttle value, and/or a last interrupt time. As an interrupt is received by the host device 110, the interrupt accumulation may be incremented and a timestamp may be recorded, which may include updating the last interrupt time. In instances in which the interrupt is a stale interrupt, the stale interrupt accumulation may be incremented.

In instances in which the interrupt accumulation is greater than a threshold number of interrupts and the stale interrupt accumulation is greater than a threshold number of stale interrupts, the interrupt throttle value may be incremented (e.g., by a delta value) and the interrupt throttle value may be set to the greater of the incremented interrupt throttle value and a maximum interrupt throttle value (e.g., the interrupt throttle value may be limited to not exceed the maximum interrupt throttle value). The threshold number of stale interrupts may be a small value multiplied by the interrupt accumulation, where the small value may be determined experimentally. The threshold can be approximated numerically as one divided by power of two to reduce computational complexity of the implementation.

Alternatively, or additionally, in instances in which the interrupt accumulation is greater than a threshold number of interrupts, but the stale interrupt accumulation is less than or equal to a threshold number of stale interrupts, the interrupt throttle value may be decremented by the delta value and the interrupt throttle value may be set to the greater of the decremented interrupt throttle value and zero (e.g., the interrupt throttle value may be limited to not be less than zero). In these and other instances, when the interrupt accumulation is greater than a threshold number of interrupts and the aforementioned additional processes are taken relative to the interrupt throttle value, at least the interrupt accumulation and/or the stale interrupt accumulation may be reset (e.g., reset to zero).

In instances in which an amount of time between a current interrupt and a previous interrupt satisfies a threshold amount of time, the interrupt throttle value may be reset (e.g., reset to zero). In some instances, the threshold amount of time may be a predetermined value, such as 100 milliseconds. Alternatively, or additionally, the threshold amount of time may be input by a user, adjusted to be a different value, and/or automatically adjusted based on previous interrupt values, previous threshold amounts of time, bandwidth of the data transform accelerator 120, bandwidth of the host device 110, bandwidth of the interface between the data transform accelerator 120 and the host device 110, and/or other aspects of the system 100 and/or components therein.

In some instances, the interrupt throttle value may be dynamically adjusted based on throughput trends determined in the data transform engines in the data transform accelerator 120. The host device 110 may be operable to perform an estimation of the throughput based on sampling. At predefined sampling epochs, the host device 110 may estimate the sample throughput of transformations performed by the data transform accelerator 120. The estimation may be based on the number of completed commands submitted within the containers 122, may be categorized by different classes of service, and/or may be distributed across multiple banks of data transform engines in the data transform accelerator 120.

In some instances, the host device 110 may be operable to analyze throughput trends by applying a linear regression algorithm (or other suitable learning algorithms) to determine the slope of the throughput over time. The estimation may be first-order (linear), or higher-order (non-linear), which may be based on the complexity of the throughput variations. In some instances, the estimated slope (or higher-order throughput) change may be compared to a programmed target threshold. The comparison may inform subsequent decisions regarding behavior of the system and/or optimization strategies.

In instances in which the slope (or higher-order statistics) fall below the target threshold, it may be inferred that the application may be in a steady state, or may indicate that the application may have completed a startup phase. In such instances, interrupt throttling may be initiated to enhance performance. By reducing the overhead of interrupt processing, CPU cycles may be reallocated to the application, which may enable higher data submission rates and/or tradeoffs in latency for improved throughput.

Alternatively, or additionally, in instances in which the slope satisfies a predefined threshold, the application may not be stabilized and may still be ramping up a submission rate, and/or not completed a startup phase. In such instances, interrupt throttling may be deferred and/or the host device 110 may continue to monitor and estimate throughput dynamics to determine optimization of interrupt throttling. In some instances, interrupt throttling (e.g., interrupt rate control) may be disabled during the startup phase and/or during phases of a workload transition. In such instances, the transitions may be identified by estimating throughput trends using linear regression and/or other learning algorithms, such as the throughput trends observed in the host device 110 and/or the data transform accelerator 120.

In some instances, the adaptive rate control in the system 100 may be configured to operate in three distinct states, which may include a saturation state, a normal state, and a paused state. The adaptive rate control may be operable to dynamically adjust interrupt throttle values based on observed throughput trends. The adaptive rate control mechanism may enable intelligent control of resources of the system 100 to optimize performance under varying workload conditions in the system 100.

In the saturation state, a fixed-size buffer may be maintained to store recent throughput samples. Once the buffer is full, the adaptive rate control mechanism may apply a linear regression to estimate the slope of the throughput change. The estimated slope of the throughput change may be compared to a predefined target value. In instances in which the estimated slope indicates a stabilization (e.g., below the predefined target value), the state may transition to the normal state for finer control.

In the normal state, an exponential moving average (EMA) of the throughput may be continuously updated. Alternatively, or additionally, the current EMA may be compared with a prior EMA to determine performance trends in the system 100. In instances in which the throughput is decreasing, a negative (or a decrement) adjustment may be applied to the interrupt throttle value. In instances in which the throughput is increasing or stable, a positive (or an increment) adjustment may be applied to the interrupt throttle value. In some instances, the system 100 may transition from the normal state to the paused state, which may contribute to the system 100 settling and/or avoiding over-adjustment by the adaptive rate control mechanism. In some instance, the interrupt throttle value may be updated (e.g., based on the determinations described relative to the normal state) and/or may be written to a hardware register. In instances in which the interrupt throttle value satisfies (e.g., exceeds) a maximum threshold, the adaptive rate control mechanism may be reset, which may contribute to preventing instability in the system 100.

In the paused state, the system 100 may continue to monitor the throughput using EMA updates, as described. In some instances, the system 100 may decrement a pause counter to control a duration of the paused state. In instances in which the pause counter satisfies a threshold, a period in the paused state may end and the system 100 may transition from the paused state to the normal state for continued adaptive rate control.

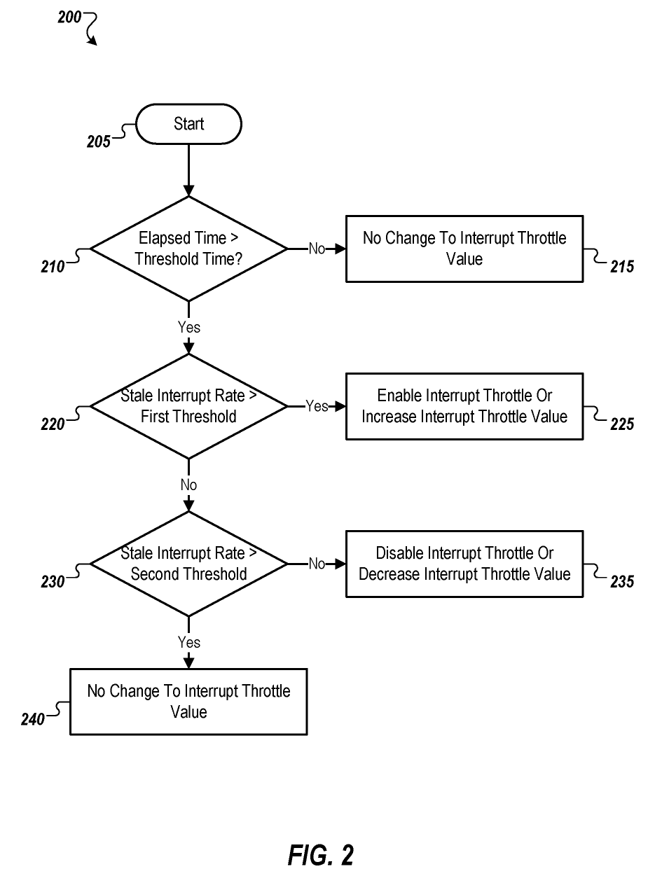

FIG. 2 illustrates an example flowchart 200 for interrupt rate control in a data transform accelerator, such as with respect to the system 100 of FIG. 1. The flowchart 200 may begin at block 205, where at least an elapsed time and/or a threshold time may be obtained. At block 210, the elapsed time may be compared to the threshold time to determine if an interrupt throttle value may be considered for an update. In instances in which the elapsed time is less than the threshold time, block 215 may direct that no change be made to the interrupt throttle value.

At block 220, a comparison of the stale interrupt ratio (e.g., the stale interrupt rate relative to the total interrupt rate, as described herein) to one or more stale interrupt thresholds (e.g., an upper stale interrupt threshold and/or a lower stale interrupt threshold) may be made. In instances in which the stale interrupt ratio is greater than the upper stale interrupt threshold, at block 225, the interrupt throttle may be enabled using an initial value. In instances in which the interrupt throttle may already be enabled, block 225 indicates that the interrupt throttle value may be updated from a previously stored value. In instances in which the interrupt throttle value is updated, host software in the host device may increase the interrupt throttle value from a previously set interrupt throttle value, which may reduce the number of interrupts from the data transform accelerator. Alternatively, in instances in which the stale interrupt ratio is not greater than the upper stale interrupt threshold, there may be no change made to the interrupt throttle value.

At block 230, a comparison of the stale interrupt ratio to the lower stale interrupt threshold may be made. In instances in which the stale interrupt ratio is lower than the lower stale interrupt threshold, the interrupt throttle value may be updated to be a lower value than the currently set interrupt throttle value and/or the interrupt throttle may be disabled. In some instances, the lower stale interrupt threshold may relate to and/or be based on a workload associated with the system (e.g., the system 100 illustrated in FIG. 1). For example, the lower stable interrupt threshold may be based on the a block size of data transform operations, a number of IO operations at the data transform accelerator, a complexity of the data transform operations, a processing time associated with the data transform accelerator, and/or resources available to the data transform accelerator (e.g., resources on a connected server device). The resources for the data transform accelerator may include, but not be limited to, CPU clock, memory bandwidth, memory latency, IO latency, memory bank size, and/or non-uniform memory access (NUMA) architecture.

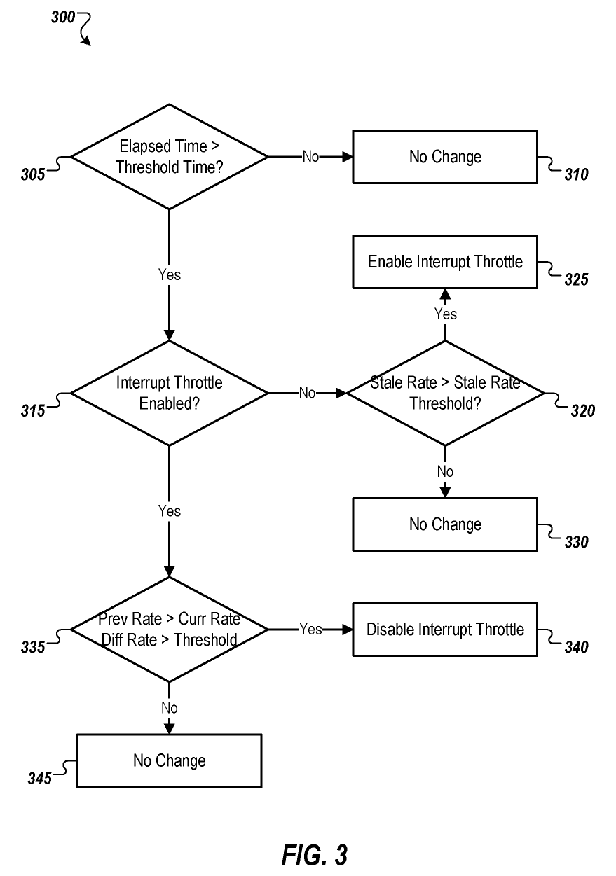

FIG. 3 illustrates an example flowchart 300 for interrupt rate control in a data transform accelerator, such as with respect to the system 100 of FIG. 1. The flowchart 300 may begin at block 305, where an elapsed time may be compared to a threshold time to determine if the interrupt throttle may be considered for an update. In instances in which the elapsed time is less than the threshold time, at block 310, no change may be made to the interrupt throttle.

At block 315, a check may be made if the interrupt throttle is enabled. In instances in which the interrupt throttle is not enabled, the flowchart 300 may proceed to block 320, where a stale interrupt rate may be compared against a stale interrupt threshold. In instances in which the stale interrupt rate is greater than the stale interrupt threshold, at block 325, the interrupt throttle may be enabled, using a pre-determined value. In instances in which the stale interrupt rate is less than the stale interrupt threshold, at block 330, there may be no change to the interrupt throttle.

At block 335, the interrupt throttle may be enabled (as determined from block 315) and the previous stale interrupt rate may be compared to a current stale interrupt rate, and the results of the first comparison (e.g., the previous stale interrupt rate compared the current stale interrupt rate) may be compared to a stale interrupt threshold. In instances in which the previous stale interrupt rate is greater than the current stale interrupt rate and the comparison of the stale interrupt rates are greater than the stale interrupt threshold, at block 340, the interrupt throttle may be disabled. Alternatively, if either the first comparison or the second comparison from block 335 may not be satisfied, at block 345, the interrupt throttle may remain enabled.

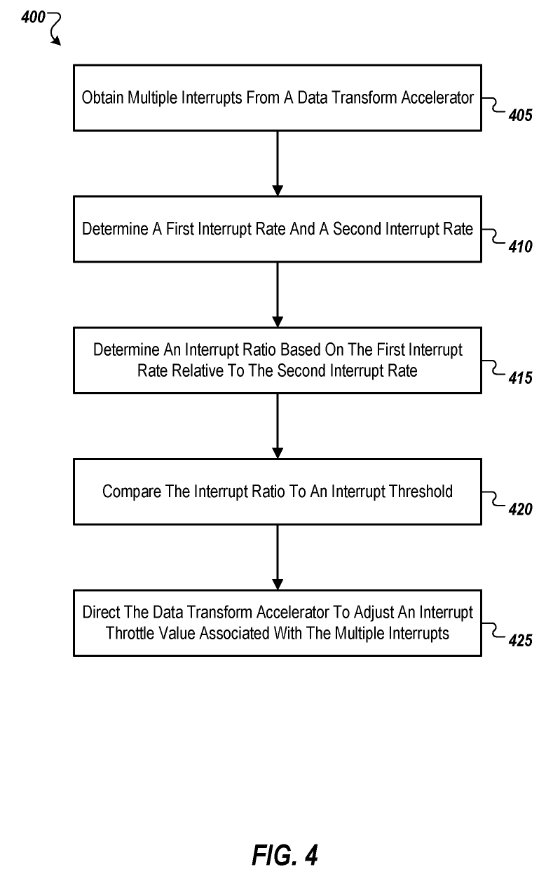

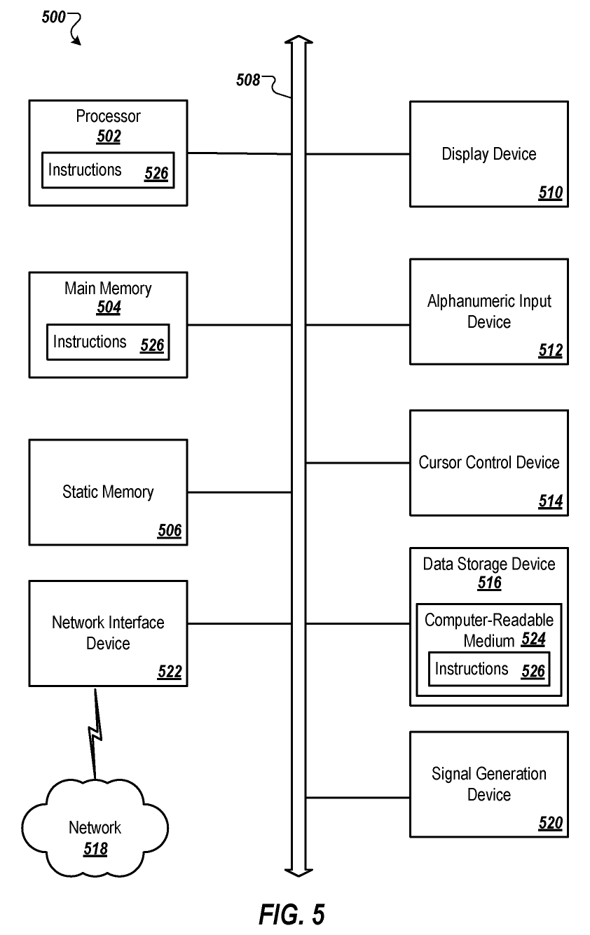

FIG. 4 illustrates a flowchart of an example method 400 for interrupt rate control in a data transform accelerator. The method 400 may be performed by processing logic that may include hardware (circuitry, dedicated logic, etc.), software (such as is run on a general purpose computer system or a dedicated machine), or a combination of both, which processing logic may be included in any computer system or device such as the host device 110 of FIG. 1 and/or the computing device 500 of FIG. 5.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 400 may begin at block 405 where processing logic may obtain multiple interrupts from a data transform accelerator.

At block 410, the processing logic may determine a first interrupt rate and a second interrupt rate. In some instances, the first interrupt rate may be a stale interrupt rate determined based on a difference between a current number of stale interrupts and a previous number of stale interrupts. A stale interrupt may be an interrupt with no pending work. In some instances, the second interrupt rate may be a total interrupt rate determined based on a difference between a current number of total interrupts and a previous number of total interrupts.

In some instances, the first interrupt rate may be determined by sampling a current number of first interrupts and a previous number of first interrupts over a time interval. Alternatively, or additionally, the second interrupt rate may be determined by sampling a current number of second interrupts and a previous number of second interrupts over the time interval.

At block 415, the processing logic may determine an interrupt ratio based on the first interrupt rate relative to the second interrupt rate. In some instances, determining the interrupt ratio may include the first interrupt rate divided by the second interrupt rate.

At block 420, the processing logic may compare the interrupt ratio to an interrupt threshold. In some instances, the interrupt threshold may be determined using one or more of empirical determination, derived using a synthetic workload test, and/or monitoring a workload associated with the host device.

At block 425, the processing logic may direct the data transform accelerator to adjust an interrupt throttle value associated with the multiple interrupts. In some instances, the adjusting of the interrupt throttle value may be in response to the interrupt ratio satisfying the interrupt threshold. In response to the interrupt ratio satisfying an upper interrupt threshold, the processing logic may direct the data transform accelerator to increase the interrupt throttle value. Increasing the interrupt throttle value may causes the data transform accelerator to reduce a number of the multiple interrupts transmitted from the data transform accelerator to the host device. In some instances, the interrupt throttle value may be disabled during a startup phase or a workload transition period. The workload transition period may be identified by estimating throughput trends in the host device.

In response to the interrupt ratio satisfying a lower interrupt threshold, the processing logic may direct the data transform accelerator to disable interrupt throttling between the data transform accelerator and the host device. Alternatively, or additionally, in response to the interrupt ratio satisfying a lower interrupt threshold, the processing logic may direct the data transform accelerator to decrease the interrupt throttle value. Decreasing the interrupt throttle value may cause the data transform accelerator to increase a number of the multiple interrupts transmitted from the data transform accelerator to the host device.

Modifications, additions, or omissions may be made to the method 400 without departing from the scope of the present disclosure. For example, the designations of different elements in the manner described is meant to help explain concepts described herein and is not limiting. Further, the method 400 may include any number of other elements or may be implemented within other systems or contexts than those described.

FIG. 5 illustrates an example computing device 500 within which a set of instructions, for causing the machine to perform any one or more of the methods discussed herein, may be executed. The computing device 500 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 500 includes a processing device 502 (e.g., a processor), a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 516, which communicate with each other via a bus 508.

The processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also include one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In at least one implementation, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over a network 518 via the network interface device 522.

While the computer-readable storage medium 524 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method, comprising:
obtaining, by a host device, a plurality of interrupts from a data transform accelerator;
determining, by the host device, a first interrupt rate and a second interrupt rate;
determining, by the host device, an interrupt ratio based on the first interrupt rate relative to the second interrupt rate;
comparing the interrupt ratio to an interrupt threshold; and
in response to the interrupt ratio satisfying the interrupt threshold, directing, by the host device, the data transform accelerator to adjust an interrupt throttle value associated with the plurality of interrupts.

2. The method of claim 1, wherein the first interrupt rate comprises a stale interrupt rate determined based on a difference between a current number of stale interrupts and a previous number of stale interrupts, and wherein a stale interrupt comprises an interrupt with no pending work.

3. The method of claim 1, wherein the second interrupt rate comprises a total interrupt rate determined based on a difference between a current number of total interrupts and a previous number of total interrupts.

4. The method of claim 1, wherein determining the interrupt ratio comprises the first interrupt rate divided by the second interrupt rate.

5. The method of claim 1, wherein in response to the interrupt ratio satisfying an upper interrupt threshold, directing, by the host device, the data transform accelerator to increase the interrupt throttle value.

6. The method of claim 5, wherein increasing the interrupt throttle value causes the data transform accelerator to reduce a number of the plurality of interrupts transmitted from the data transform accelerator to the host device.

7. The method of claim 1, wherein in response to the interrupt ratio satisfying a lower interrupt threshold, directing, by the host device, the data transform accelerator to decrease the interrupt throttle value.

8. The method of claim 7, wherein decreasing the interrupt throttle value causes the data transform accelerator to increase a number of the plurality of interrupts transmitted from the data transform accelerator to the host device.

9. The method of claim 1, wherein in response to the interrupt ratio satisfying a lower interrupt threshold, directing, by the host device, the data transform accelerator to disable interrupt throttling between the data transform accelerator and the host device.

10. The method of claim 1, wherein the first interrupt rate is determined by sampling a current number of first interrupts and a previous number of first interrupts over a time interval, and the second interrupt rate is determined by sampling a current number of second interrupts and a previous number of second interrupts over the time interval.

11. The method of claim 1, wherein the interrupt threshold is determined using one or more of empirical determination, derived using a synthetic workload test, and monitoring a workload associated with the host device.

12. The method of claim 1, wherein the interrupt throttle value is disabled during a startup phase or a workload transition period, where the workload transition period is identified by estimating throughput trends in the host device.

13. A computing system, comprising:
a processor;
a memory storing instructions that, when executed by the processor, cause the computing system to:
obtain, by a host device, a plurality of interrupts from a data transform accelerator;
determine, by the host device, a first interrupt rate and a second interrupt rate;
determine, by the host device, an interrupt ratio based on the first interrupt rate relative to the second interrupt rate;
compare the interrupt ratio to an interrupt threshold; and
in response to the interrupt ratio satisfying the interrupt threshold, direct, by the host device, the data transform accelerator to adjust an interrupt throttle value associated with the plurality of interrupts.

14. The computing system of claim 13, wherein the first interrupt rate comprises a stale interrupt rate determined based on a difference between a current number of stale interrupts and a previous number of stale interrupts, and wherein a stale interrupt comprises an interrupt with no pending work.

15. The computing system of claim 13, wherein the second interrupt rate comprises a total interrupt rate determined based on a difference between a current number of total interrupts and a previous number of total interrupts.

16. The computing system of claim 13, wherein determining the interrupt ratio comprises the first interrupt rate divided by the second interrupt rate.

17. The computing system of claim 13, wherein:
in response to the interrupt ratio satisfying an upper interrupt threshold, direct, by the host device, the data transform accelerator to increase the interrupt throttle value; and
increasing the interrupt throttle value causes the data transform accelerator to reduce a number of the plurality of interrupts transmitted from the data transform accelerator to the host device.

18. The computing system of claim 13, wherein:
in response to the interrupt ratio satisfying a lower interrupt threshold, direct, by the host device, the data transform accelerator to decrease the interrupt throttle value; and
decreasing the interrupt throttle value causes the data transform accelerator to increase a number of the plurality of interrupts transmitted from the data transform accelerator to the host device.

19. The computing system of claim 13, wherein in response to the interrupt ratio satisfying a lower interrupt threshold, direct, by the host device, the data transform accelerator to disable interrupt throttling between the data transform accelerator and the host device.

20. The computing system of claim 13, wherein the first interrupt rate is determined by sampling a current number of first interrupts and a previous number of first interrupts over a time interval, and the second interrupt rate is determined by sampling a current number of second interrupts and a previous number of second interrupts over the time interval.
